(19) United States
(12) Patent Application Publication
(10) Pub. No.: US 2021/0294501 A1
(43) Pub. Date: Sep. 23, 2021

(54) STORAGE DEVICE AND CONTROL METHOD

(71) Applicant: Kioxia Corporation, Tokyo (JP)

(72) Inventors: Yuta KAGEYAMA, Yokohama (JP); Atsushi YAMAZAKI, Hachioji (JP)

(73) Assignee: Kioxia Corporation, Tokyo (JP)

(21) Appl. No.: 17/020,376

(22) Filed: Sep. 14, 2020

(30) Foreign Application Priority Data
Mar. 19, 2020 (JP) 2020-049109

(51) Int. Cl. G06F 3/06

(52) U.S. Cl. CPC G06F 3/0614; G06F 3/0655; G06F 3/0679

(57) ABSTRACT

According to one embodiment, a storage device is communicably connected to a server device. The storage device includes a nonvolatile memory and a controller which controls the nonvolatile memory. The controller transmits log data stored in the nonvolatile memory to the server device when a logical failure occurs in the nonvolatile memory, and erases the log data from the nonvolatile memory.

### CROSS-REFERENCE TO RELATED APPLICATIONS

This application is based upon and claims the benefit of priority from Japanese Patent Application No. 2020-049109, filed Mar. 19, 2020, the entire contents of which are incorporated herein by reference.

### FIELD

Embodiments described herein relate generally to a storage device and a control method.

### BACKGROUND

Recently, data leakage prevention has been drawing attention. Therefore, a storage device having a data protection function of preventing data read by a third party or the like has been widely used. In a case where a failure occurs in the storage device having the data protection function, its recovery work takes time and effort. In addition, in the storage device, other than user data, data indicating the operation history of the storage device is stored.

Therefore, there has been demand for realization of a mechanism for efficiently recovering the failure having occurred in the storage device while preventing leakage of these data to the third party.

### BRIEF DESCRIPTION OF THE DRAWINGS

FIG. 1 is a block diagram showing a schematic configuration example of an information processing system including a storage device according to an embodiment.

FIG. 2 is a block diagram for explaining the data structure of log data.

FIG. 3 is a block diagram for explaining the data structure of recovery data.

FIG. 4 is a timing chart of recovery processing executed in the information processing system according to the embodiment.

FIG. 5 is a timing chart showing an example of the procedure of a series of processes executed between the storage device according to the embodiment and a server device.

FIG. 6 is another timing chart of the recovery processing executed in the information processing system according to the embodiment.

FIG. 7 is another timing chart of the recovery processing executed in the information processing system according to the embodiment.

### DETAILED DESCRIPTION

In general, according to one embodiment, a storage device communicably connected to a server device comprises a nonvolatile memory and a controller which controls the nonvolatile memory. The controller transmits log data stored in the nonvolatile memory to the server device when a logical failure occurs in the nonvolatile memory, and erases the log data from the nonvolatile memory.

Embodiments will be described hereinafter with reference to the accompanying drawings.

The disclosure is merely an example, and proper changes in keeping with the spirit of the invention, which are easily conceivable by a person with ordinary skill in the art, come within the scope of the invention as a matter of course. In addition, in some cases, in order to make the description clearer, the widths, thicknesses, shapes, etc., of the respective parts are illustrated schematically in the drawings, rather than as an accurate representation of what is implemented. However, such schematic illustration is merely exemplary, and in no way restricts the interpretation of the invention. In addition, in the specification and drawings, structural elements which function in the same or a similar manner to those described in connection with preceding drawings are denoted by the same numbers, and detailed explanations of them which are considered redundant may be omitted.

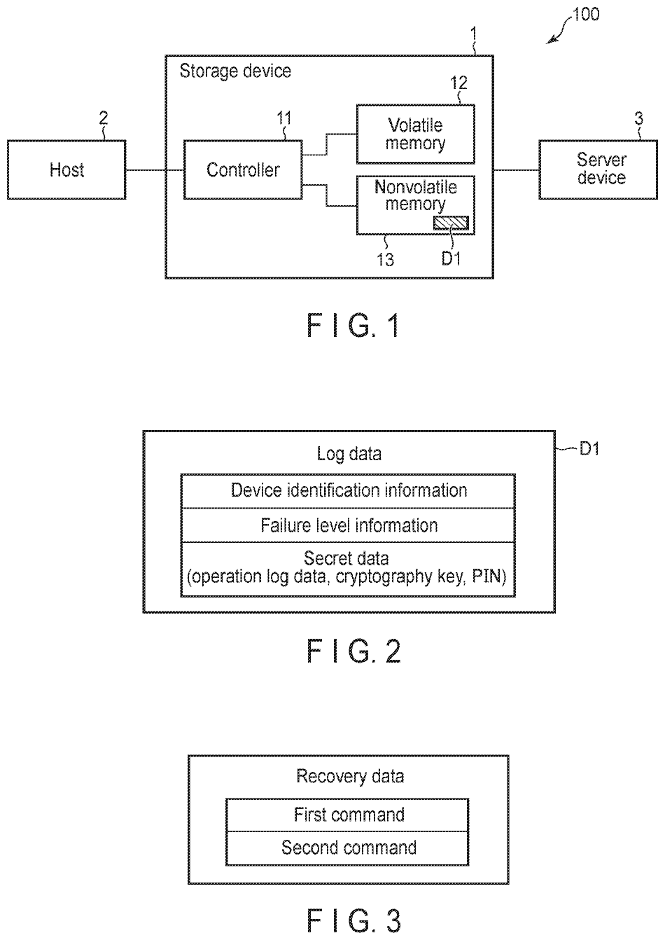

FIG. 1 is a block diagram showing a schematic configuration example of an information processing system 100 including a storage device 1 according to the present embodiment.

As shown in FIG. 1, the information processing system 100 includes the storage device 1, a host (host device) 2 and a server device 3.

The storage device 1 is a storage having a data protection function. The storage device 1 may be realized as, for example, a solid state drive (SSD) or a hard disk drive (HDD). As the data protection function, there are various types such as an encryption type which encrypts and stores data, a lock type which prohibits access to a storage region assigned to a certain person from a person different from the certain person, and an encryption/lock type which is a combination of the encryption type and the lock type. The storage device 1 can employ any one of these data protection functions. As the standard of the data protection function, there are, for example, a trusted computing group (TCG) and the like. In addition, as the standard for data protection by encryption, for example, opal is formulated in the TCG.

The host 2 is an information processing device outside the storage device 1. The host 2 uses the storage device 1 as a storage. The host 2 may be a personal computer (PC), a portable device such as a tablet computer or a smartphone, or an in-car device such as a car navigation system. The storage device 1 and the host 2 are interconnected via a cable or a network. As the interface for interconnecting the storage device 1 and the host 2, PCI Express (PCIe) (registered trademark), NVM Express (NVMe) (registered trademark), Ethernet (registered trademark), NVMe over Fabrics (NVMeOF), and the like may be used.

The server device 3 is communicably connected to the storage device 1 (more specifically, the host 2 connected to the storage device 1) via a cable or a network.

The storage device 1 comprises a controller 11, a volatile memory 12 and a nonvolatile memory 13.

When an input of a read command is received, the controller 11 executes processing of reading requested data from the nonvolatile memory 13 (read processing). When an input of a write command is received, the controller 11 executes processing of storing transferred data in the nonvolatile memory 13 (write processing). In a case where the data protection function is the encryption type or in a case where the data protection function is the encryption/lock type, when data is written to the nonvolatile memory 13, the controller 11 encrypts the data using a cryptography key. On the other hand, when data is read from the nonvolatile memory 13, the controller 11 decrypts encrypted data using the same cryptography key as the cryptography key used for encryption.

The volatile memory 12 is, for example, a dynamic RAM (DRAM). Note that the volatile memory 12 may be provided in the controller 11. The volatile memory 12 functions as a cache in the read processing or the write processing. In addition, the volatile memory 12 may be used as a destination to which a program is loaded from the nonvolatile memory 13, a work area for the program, and the like.

The nonvolatile memory 13 is, for example, a NAND flash memory. The NAND flash memory as a form of the nonvolatile memory 13 includes a memory cell array. The memory cell array includes a plurality of memory cells arranged in a matrix. The NAND flash memory includes a plurality of blocks as storage regions.

In the nonvolatile memory 13, other than a storage region in which user data can be stored, there is a storage region in which log data D1 of the operation of the storage device 1 is stored (hereinafter referred to as a secret storage region). The secret storage region is a storage region different from a storage region which the host 2 can access. A function restriction which is a restriction for prohibiting access to the secret storage region from the host 2 is set to the storage device 1. Accordingly, the host 2 cannot access the secret storage region or cannot access the log data D1 stored in the secret storage region.

In the present embodiment, the handling of the log data D1 in a case where a logical trouble (hereinafter referred to as a logical failure) occurs in the storage device 1 and the procedure for recovering the storage device 1 from the logical failure will be mainly explained.

Note that the logical failure indicates, for example, a situation where data stored in the nonvolatile memory 13 itself is corrupted and the data cannot be read, a situation where the cryptography key of data stored in the nonvolatile memory 13 is corrupted and the data cannot be read, and the like. A firmware failure which may occur in firmware which can be used by directly controlling the nonvolatile memory 13 is also included in the logical failure.

FIG. 2 is a block diagram for explaining the data structure of the log data D1.

The log data D1 includes device identification information, failure level information and secret data. The log data D1 is stored in, for example, the secret storage region. The device identification information (device ID) is unique information for identifying the storage device 1. The device identification information is, for example, the serial number (such as NAND serial) of the storage device 1. The failure level information is information indicating the level of a logical failure having occurred in the storage device 1. The secret data is data included in the log data D1 whose leakage should be particularly prevented.

The secret data includes operation log data, a cryptography key and a personal identification number (PIN). The operation log data is the operation history of the storage device 1. The cryptography key is the cryptography key of user data stored in the nonvolatile memory 13. The PIN is the personal identification information about the manager of user data stored in the nonvolatile memory 13.

FIG. 3 is a block diagram for explaining the data structure of recovery data.

The recovery data includes a command for removing the function restriction set to the storage device 1 (a first command) and a command for recovering the storage device 1 (a second command). An example of the first command is unlock which is a command for removing a personal authentication function using a PIN which is a data protection function. An example of the second command is revert which is a command for deactivating a data protection function and invalidating data stored in the nonvolatile memory 13. Revert is a command for initialization. The initialization of data by revert is carried out by, for example, updating a cryptography key. An example of the second command is FW download which is a command for downloading firmware.

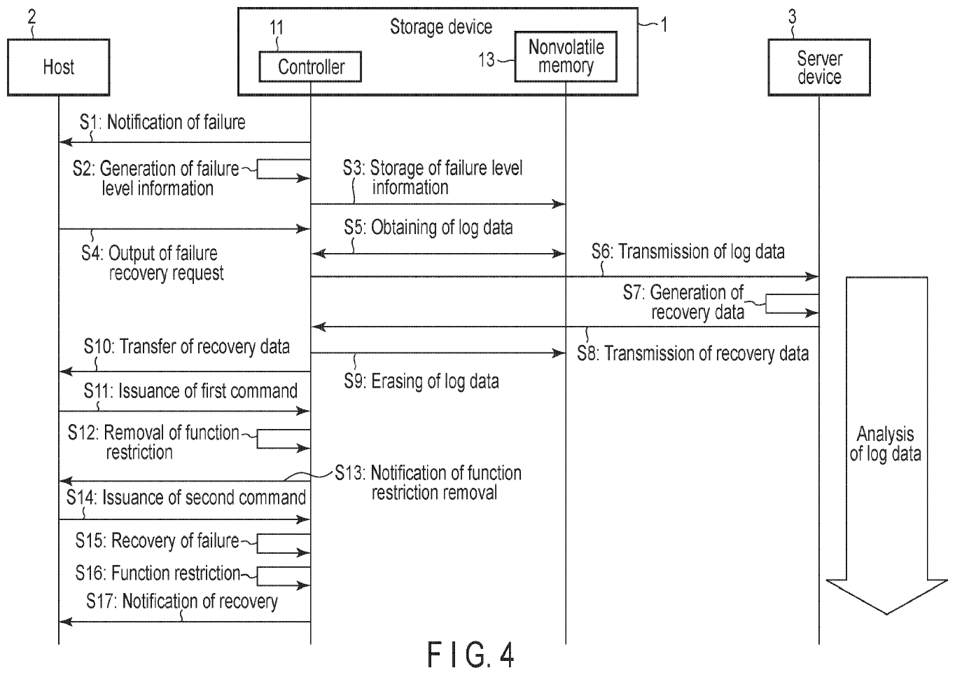

FIG. 4 is a timing chart of recovery processing executed in the information processing system 100 according to the present embodiment.

When it is detected that a logical failure has occurred in the nonvolatile memory 13, the controller 11 of the storage device 1 notifies it to the host 2 (notification of failure, S1). In addition, when it is detected that a logical failure has occurred in the nonvolatile memory 13, the controller 11 of the storage device 1 evaluates the occurred logical failure. The controller 11 of the storage device 1 generates failure level information which is information indicating the level of the occurred logical failure (generation of failure level information, S2). In addition, the controller 11 of the storage device 1 stores the generated failure level information in the secret storage region of the nonvolatile memory 13 as log data D1 (storage of failure level information, S3).

When the notification of the failure is received from the storage device 1, the host 2 outputs a failure recovery request to the storage device 1 (output of failure recovery request, S4). The failure recovery request is a request to the storage device 1 to start processing of recovering the logical failure having occurred in the nonvolatile memory 13. In order to output the failure recover request to the storage device 1, the host 2 uses, for example, a vendor command.

When the failure recovery request is received from the host 2, the controller 11 of the storage device 1 obtains (reads) the log data D1 stored in the secret storage region of the nonvolatile memory 13 (obtaining of log data, S5). The controller 11 of the storage device 1 transmits the obtained log data D1 to the server device 3 (transmission of log data, S6).

When the log data D1 is received from the storage device 1, the server device 3 generates recovery data based on the failure level information included in the received log data D1 (generation of recovery data, S7). The recovery data includes the command for removing the function restriction set to the storage device 1 (the first command) and the command for recovering the storage device 1 (the second command). The recovery data may be automatically generated by the server device 3 according to the level of the failure indicated by the failure level information. Alternatively, the recovery data may be generated by the manager of the server device 3 according to the level of the failure indicated by the failure level information. The server device 3 transmits the generated recovery data to the storage device 1 (transmission of recovery data, S8).

When the recovery data is received from the server device 3, the controller 11 of the storage device 1 erases the log data D1 stored in the secret storage region of the nonvolatile memory 13 (erasing of log data, S9). Note that the controller 11 of the storage device 1 may erase the log data D1 not when the recovery data is received from the server device 3 but when the log data D1 is transmitted to the server device 3. In other words, the controller 11 of the storage device 1 may erase the log data D1 with any timing from after the log data D1 is transmitted to the server device 3 to immediately before the function restriction is removed. The controller 11 of the storage device 1 transfers the received recovery data to the host 2 (transfer of recovery data, S10).

When the recovery data is received from the storage device 1, the host 2 issues the first command included in the received recovery data to the storage device 1 (issuance of first command, S11).

When the first command is received from the host 2, the controller 11 of the storage device 1 removes the function restriction set to the storage device 1 based on the received first command (removal of function restriction, S12). For example, in a case where the first command is an unlock command, the controller 11 of the storage device 1 removes the function restriction set to the storage device 1 by removing the personal authentication function using the PIN. Accordingly, the access to the secret storage region from the host 2 is permitted. The controller 11 of the storage device 1 notifies the host 2 that the function restriction set to the storage device 1 is removed (notification of function restriction removal, S13).

When the notification of the function restriction removal is received from the storage device 1, the host 2 issues the second command included in the recovery data received from the storage device 1 to the storage device 1 (issuance of second command, S14).

When the second command is received from the host 2, the controller 11 of the storage device 1 recovers the logical failure having occurred in the nonvolatile memory 13 based on the received second command (recovery of failure, S15). For example, in a case where the second command is a revert command, the controller 11 of the storage device 1 recovers the logical failure by initializing the nonvolatile memory 13. In addition, in a case where the second command is an FW download command, the controller 11 of the storage device 1 recovers the logical failure by downloading and reinstalling firmware.

After the logical failure is recovered, the controller 11 of the storage device 1 resets the function restriction to the storage device 1 (resetting of function restriction, S16). Accordingly, the access to the secret storage region from the host 2 is prohibited. Note that the controller 11 of the storage device 1 here automatically resets the function restriction along with the recovery of the logical failure having occurred in the nonvolatile memory 13. However, the controller 11 of the storage device 1 may reset the function restriction when an instruction is received from the host 2.

After the function restriction is reset, the controller 11 of the storage device 1 notifies the host 2 that the logical failure having occurred in the nonvolatile memory 13 is recovered (notification of recovery, S17), and ends the series of processes of the recovery processing here. After the notification of the recovery is received from the storage device 1, the host 2 resumes operations at normal times (such as issuance of a write command and issuance of a read command).

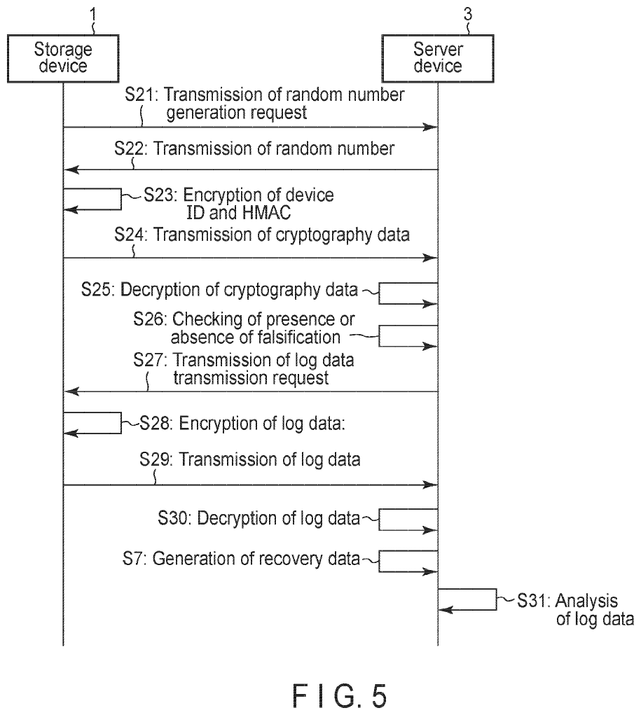

Here, an example of the procedure of the series of processes executed between the storage device 1 and the server device 3 will be explained with reference to the timing chart of FIG. 5.

When a failure recovery request is received from the host 2, the storage device 1 transmits a random number generation request to the server device 3 (transmission of random number generation request, S21). The random number generation request is a request to the server device 3 to generate a random number which is a cryptography key for encrypting log data D1.

When the random number generation request is received from the storage device 1, the server device 3 generates a random number which serves as a cryptography key. The server device 3 transmits the generated random number to the storage device 1 (transmission of random number, S22).

When the random number is received from the server device 3, the storage device 1 encrypts a device ID of its own and a hash-based message authentication code (HMAC) calculated based on the device ID using the received random number (encryption of device ID and HMAC, S23). The storage device 1 transmits cryptography data indicating the encrypted device ID of its own and the encrypted HMAC to the server device 3 (transmission of cryptography data, S24).

When the cryptography data is received from the storage device 1, the server device 3 decrypts the received cryptography data using the random number generated when the random generation request is received from the storage device 1 (decryption of cryptography data, S25).

The server device 3 recognizes the device ID of the storage device 1 and the HMAC calculated based on the device ID of the storage device 1 which are obtained by decrypting the cryptography data. The server device 3 calculates the HMAC based on the recognized device ID of the storage device 1. The server device 3 determines whether the calculated HMAC and the recognized HMAC are the same or not, and checks whether the recognized device ID of the storage device 1 is falsified or not (checking of presence or absence of falsification, S26). Note that processes executed when the server device 3 checks that the recognized device ID of the storage device 1 is not falsified will be described below.

The server device 3 transmits a log data transmission request to the storage device 1 (transmission of log data transmission request, S27). The log data transmission request is a request for transmitting the log data D1 stored in the secret storage region.

When the log data transmission request is received from the server device 3, the storage device 1 obtains the log data D1 stored in the secret storage region of the nonvolatile memory 13. The storage device 1 encrypts the obtained log data D1 using the random number (cryptography key) received from the server device 3 (encryption of log data, S28). The storage device 1 transmits the encrypted log data D1 to the server device 3 (transmission of log data, S29).

When the encrypted log data D1 is received from the storage device 1, the server device 3 decrypts the encrypted log data D1 using the random number generated when the random number generation request is received from the storage device 1 (decryption of log data, S30). After that, the server device 3 executes the above-described generation of recovery data of S7. In addition, the server device 3 analyzes the logical failure having occurred in the nonvolatile memory 13 based on the decrypted log data D1 (failure analysis, S31).

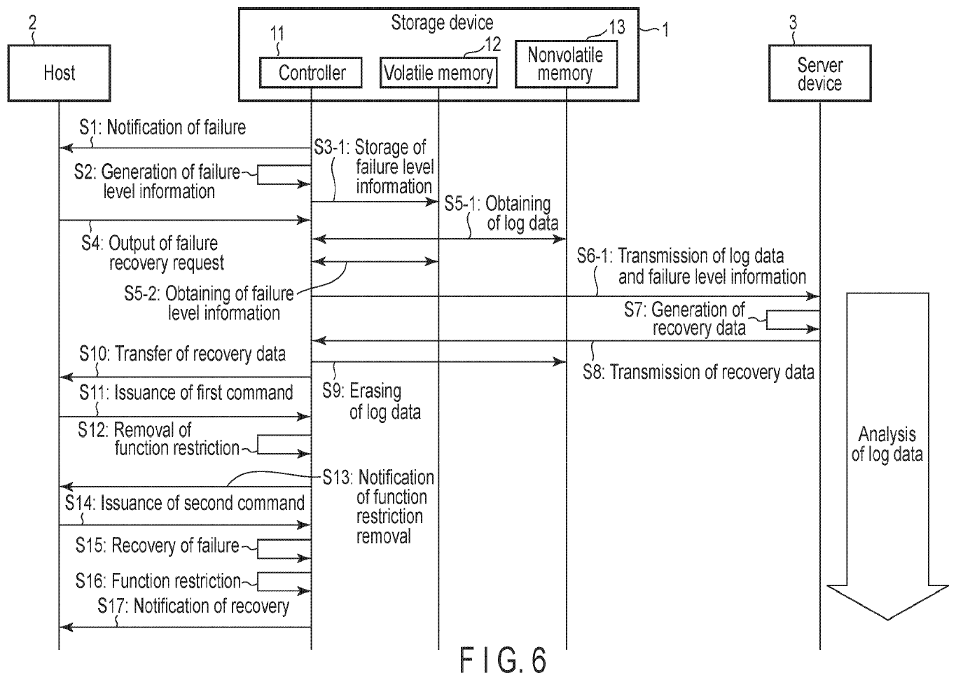

FIG. 6 is a timing chart showing an overview of another recovery processing. FIG. 6 is different from the recovery processing shown in FIG. 4 in that, due to the logical failure having occurred in the nonvolatile memory 13, the controller 11 of the storage device 1 cannot store the generated failure level information in the secret storage region of the nonvolatile memory 13 as the log data D1. Note that the same processes as those of the recovery processing of FIG. 4 are denoted by the same reference numbers, and detailed explanations of them are omitted here.

In this case, after the above-described process of S2, the controller 11 of the storage device 1 stores the generated failure level information in the volatile memory 12 (storage of failure level information, S3-1). Then, after the failure recovery request is received from the host 2, the controller 11 of the storage device 1 obtains the log data D1 stored in the secret storage region of the nonvolatile memory 13 (obtaining of log data, S5-1). In addition, when the failure recovery request is received from the host 2, the controller 11 of the storage device 1 obtains the failure level information stored in the volatile memory 12 (obtaining of failure level information, S5-2).

The controller 11 of the storage device 1 transmits the log data D1 obtained from the nonvolatile memory 13 and the failure level information obtained from the nonvolatile memory 12 to the server device 3 (transmission of log data and failure level information, S6-1). Since the subsequent operations are the same as those of FIG. 4, the detailed explanation of them will be omitted here.

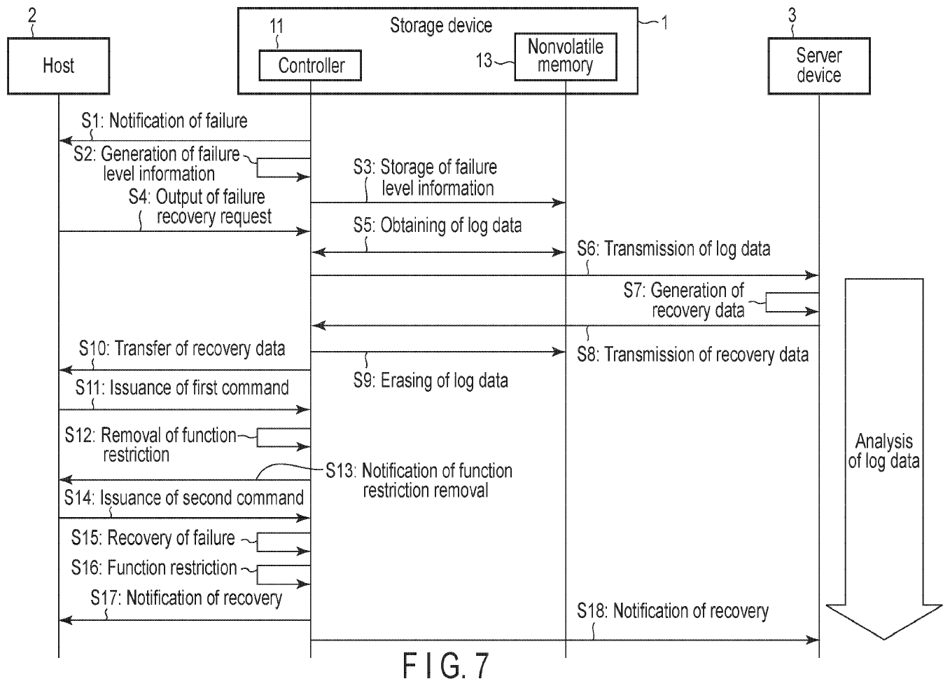

FIG. 7 is a timing chart showing an overview of another recovery processing. FIG. 7 is different from the recovery processing shown in FIG. 4 in that a process of S18 is executed. Note that the same processes as those of the recovery processing of FIG. 4 are denoted by the same reference numbers, and detailed explanations of them are omitted here.

After the above-described process of S17, the controller 11 of the storage device 1 notifies the server device 3 that the logical failure having occurred in the nonvolatile memory 13 is recovered (notification of recovery, S18). Note that the notification of the recovery transmitted to the server device 3 includes the device ID of the storage device 1, and a log of a command issued from the host 2 for recovering the logical failure having occurred in the nonvolatile memory 13. Accordingly, the manager of the server device 3 can check whether the first command and the second command included in the generated recovery data are issued from the host 2 or not.

According to the above-described embodiment, when a logical failure occurs in the nonvolatile memory 13, the controller 11 of the storage device 1 transmits the log data D1 stored in the secret storage region of the nonvolatile memory 13 to the server device 3. In addition, the controller 11 of the storage device 1 erases the log data D1 stored in the secret storage region of the nonvolatile memory 13. Then, the controller 11 of the storage device 1 removes the function restriction set to the storage device 1, and recovers the logical failure having occurred in the nonvolatile memory 13.

Accordingly, the log data D1 is erased before the function restriction is removed, and when the function restriction is removed, the log data D1 does not leak to a third party including the user of the host 2. In addition, the host 2 can recover the logical failure having occurred in the nonvolatile memory 13 of the storage device 1 simply by issuing the second command included in the recovery data transmitted from the storage device 1. That is, it is possible to efficiently recover the logical failure having occurred in the nonvolatile memory 13 of the storage device 1 while preventing leakage of the log data D1.

In addition, the server device 3 can analyze the log data D1 from when the log data D1 is received for generating the recovery data. That is, the server device 3 can investigate the failure from when the log data D1 is received for generating the recovery data. Accordingly, it is possible to recover the logical failure having occurred in the nonvolatile memory 13 of the storage device 1 and investigate the cause of the logical failure simultaneously.

Furthermore, the storage device 1 transmits the failure level information, which is information indicating the level of the logical failure having occurred in the nonvolatile memory 13, to the server device 3. Therefore, the server device 3 can generate recovery data suitable for recovering the logical failure having occurred in the nonvolatile memory 13 of the storage device 1.

In the present embodiment, a NAND flash memory is described as a form of the nonvolatile memory. However, the functions of the present embodiment are also applicable to various other nonvolatile memories such as a magnetoresistive random access memory (MRAM), a phase change random access memory (PRAM), a resistive random access memory (ReRAM) and a ferroelectric random access memory (FeRAM).

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A storage device communicably connected to a server device, the storage device comprising:
a nonvolatile memory; and
a controller configured to control the nonvolatile memory, wherein
the controller is configured to:
transmit log data stored in the nonvolatile memory to the server device when a logical failure occurs in the nonvolatile memory; and
erase the log data from the nonvolatile memory.

2. The storage device of claim 1, wherein the controller is configured to:
generate failure level information which is information indicating a level of the logical failure; and
store the failure level information in the nonvolatile memory as the log data.

3. The storage device of claim 2, wherein the controller is configured to:
receive, from the server device, recovery data which is data for recovering the logical failure; and
erase the log data from the nonvolatile memory based on the received recovery data.

4. The storage device of claim 3, wherein the recovery data is generated by the server device based on the failure level information.

5. The storage device of claim 4, wherein the recovery data includes:
a first command which is a command for removing a restriction for prohibiting access to the log data from a host which is an external information processing device; and
a second command which is a command for recovering the logical failure.

6. The storage device of claim 5, wherein the controller is configured to:
transmit the received recovery data to the host; and
remove the restriction based on the first command received from the host.

7. The storage device of claim 6, wherein the controller is configured to recover the logical failure based on the second command received from the host.

8. The storage device of claim 7, wherein the controller is configured to prohibit access to the log data from the host.

9. The storage device of claim 1, wherein the controller is configured to:
receive a cryptography key from the server device;
encrypt the log data using the received cryptography key; and
transmit the encrypted log data to the server device.

10. A control method for controlling a storage device communicably connected to a server device and comprising a nonvolatile memory, the control method comprising:
transmitting log data stored in the nonvolatile memory to the server device when a logical failure occurs in the nonvolatile memory; and
erasing the log data from the nonvolatile memory.

11. The control method of claim 10, further comprising:
generating failure level information which is information indicating a level of the logical failure; and
storing the failure level information in the nonvolatile memory as the log data.

12. The control method of claim 11, further comprising:
receiving, from the server device, recovery data which is data for recovering the logical failure; and
erasing the log data from the nonvolatile memory based on the received recovery data.

13. The control method of claim 12, wherein the recovery data is generated by the server device based on the failure level information.

14. The control method of claim 13, wherein the recovery data includes:
a first command which is a command for removing a restriction for prohibiting access to the log data from a host which is an external information processing device; and
a second command which is a command for recovering the logical failure.

15. The control method of claim 14, further comprising:
transmitting the received recovery data to the host; and
removing the restriction based on the first command received from the host.

16. The control method of claim 15, further comprising recovering the logical failure based on the second command received from the host.

17. The control method of claim 16, further comprising prohibiting access to the log data from the host.

18. The control method of claim 10, further comprising:
receiving a cryptography key from the server device;
encrypting the log data using the received cryptography key; and
transmitting the encrypted log data to the server device.
